(19) United States
(12) Patent Application Publication
(10) Pub. No.: US 2026/0227658 A1
(43) Pub. Date: Aug. 6, 2026

(54) LIGHT DIFFUSION SHEET, BACKLIGHT UNIT, LIQUID CRYSTAL DISPLAY DEVICE, INFORMATION DEVICE, AND STACKED LIGHT DIFFUSION SHEET

(71) Applicant: KEIWA Incorporated, Tokyo (JP)

(72) Inventors: Yu KARIYA, Tokyo (JP); Satoshi SHIBA, Tokyo (JP)

(73) Assignee: KEIWA Incorporated, Tokyo (JP)

(21) Appl. No.: 19/151,329

(22) PCT Filed: Feb. 9, 2024
(86) PCT No.: PCT/JP2024/004516

§ 371 Date: Jul. 27, 2025

(30) Foreign Application Priority Data
Feb. 15, 2023 (JP) 2023-021437
Feb. 8, 2024 (JP) 2024-017623

(51) Int. Cl. G02F 1/13357

(52) U.S. Cl. CPC G02F 1/133606

(57) ABSTRACT

A light diffusion sheet (43B) has a plurality of inverted substantially polygonal pyramid-shaped recesses (105) on a first surface (102a) that serves as a light emission surface or a light entrance surface. A second surface (101a) on the opposite side to the first surface (102a) is a matte surface, and a flattening layer, for example a flattening printed layer (103), constituted by a light-transmitting resin, for example light-transmitting ink (106), is provided so as to cover irregularities on the matte surface.

### TECHNICAL FIELD

The present disclosure relates to a light diffusion sheet, a backlight unit, a liquid crystal display device, an information device, and a stacked light diffusion sheet.

### BACKGROUND ART

Liquid crystal display devices (hereinafter, also referred to as liquid crystal displays) are widely used as display devices in various information devices such as smartphones and tablet terminals. As backlights of liquid crystal displays, direct-type systems in which a light source is deployed on the back surface of a liquid crystal panel are predominantly used.

In a direct-type backlight, a light diffusion sheet is used to diffuse light from a light source such as an LED (Light Emitting Diode) in order to improve the uniformity of brightness and chromaticity over the entire screen. PTL 1 discloses a light diffusion sheet (hereinafter, also referred to as a pyramid sheet) provided with a plurality of inverted pyramid-shaped recesses.

### CITATION LIST

PTL 1: Japanese Patent Application Publication No. 2011-129277

### SUMMARY OF INVENTION

### Technical Problem

However, in a conventional pyramid sheet, particularly a thin pyramid sheet having a thickness of around 120 μm or less, a problem occurs in that defects on the recess formation surface are easily visible on the display screen.

An object of the present disclosure is to make it possible to suppress the visibility of defects on a recess formation surface in a light diffusion sheet provided with a plurality of inverted substantially polygonal pyramid-shaped recesses.

### Solution to Problem

In order to achieve the above object, the inventor of the present application, having conducted various studies on the visibility of defects on the recess formation surface of a pyramid sheet, found that when the opposite surface to the recess formation surface is a matte surface, the visibility of defects on the recess formation surface is reduced in comparison with a case where the opposite surface is a flat surface. This is presumed to be due to the effect of light scattering on the matte surface. Meanwhile, having examined the brightness and brightness uniformity of the pyramid sheet, the inventor of the present application found that the brightness and brightness uniformity on the display screen are lower when the opposite surface to the recess formation surface is a matte surface than when the opposite surface is a flat surface.

Moreover, as a result of further examination, the inventor of the present application found that by forming the opposite surface to the recess formation surface of the pyramid sheet as a matte surface and covering the matte surface with light-transmitting ink so as to flatten the matte surface, the brightness and brightness uniformity are improved in comparison with a pyramid sheet on which the matte surface is exposed.

A light diffusion sheet according to the present disclosure is based on the above findings, and more specifically is a light diffusion sheet having a plurality of inverted substantially polygonal pyramid-shaped recesses provided on a first surface that serves as a light emission surface or a light entrance surface, wherein a second surface on the opposite side to the first surface is a matte surface, and a flattening printed layer constituted by light-transmitting ink is provided so as to cover irregularities on the matte surface.

With the light diffusion sheet according to the present disclosure, the visibility of defects on the recess formation surface provided with the inverted substantially polygonal pyramid-shaped recesses can be suppressed by the matte surface. Moreover, since the flattening printed layer is provided so as to cover the matte surface, the brightness and brightness uniformity can be improved in comparison with a case in which the matte surface is exposed.

Note that in the present disclosure, the “light diffusion sheet” is assumed to include a plate-form “light diffusion plate” and a film-form “light diffusion film”.

In the light diffusion sheet according to the present disclosure, the thickness of the flattening printed layer may be 5 μm or more. Thus, even a matte surface with a comparatively large surface roughness can be flattened by the flattening printed layer.

In the light diffusion sheet according to the present disclosure, a plurality of particles may be added to the flattening printed layer. Thus, scratches, sticking, and the like are less likely to occur during manufacture of the light diffusion sheet. For example, when the sheets are wound around a roll, the area where the sheets contact each other is large, making it possible to suppress the occurrence of problems such as an interference pattern, a press-bonding mark, or the like being formed on the sheet surface or the recess formation surface and the printed surface sticking together so as to cause scratches when the sheets are peeled apart. As a result, mass productivity can be improved.

In the light diffusion sheet according to the present disclosure, the average particle size of the plurality of particles may be greater than the thickness of the flattening printed layer. Thus, scratches, sticking, and the like are even less likely to occur during manufacture of the light diffusion sheet.

In the light diffusion sheet according to the present disclosure, the mass ratio of the plurality of particles to the light-transmitting ink in the flattening printed layer may be 1% or more and 10% or less. Thus, the occurrence of scratches and sticking during manufacture of the light diffusion sheet can be suppressed while suppressing reductions in the brightness and brightness uniformity.

In the light diffusion sheet according to the present disclosure, the plurality of recesses may be formed in an inverted substantially square pyramid shape and arranged in a two-dimensional matrix pattern. Thus, the light diffusion sheet can be manufactured with high accuracy so as to exhibit excellent brightness uniformity.

In the light diffusion sheet according to the present disclosure, as long as the ten-point average roughness Rz (based on JIS B 0601-1994) of the irregularities on the matte surface is around 50 μm or less, the irregularities on the matte surface can be covered and flattened by printing the light-transmitting ink.

A backlight unit according to the present disclosure is incorporated into a liquid crystal display device in order to guide light emitted from a plurality of light sources to a display screen, the backlight unit including the light diffusion sheet according to present disclosure, described above, which is provided between the display screen and the plurality of light sources.

Since the backlight unit according to the present disclosure includes the light diffusion sheet according to the present disclosure, described above, the visibility of defects on the recess formation surface of the light diffusion sheet can be suppressed while improving the brightness and the brightness uniformity.

A liquid crystal display device according to the present disclosure includes the backlight unit according to the present disclosure, described above, and a liquid crystal display panel.

Since the liquid crystal display device according to the present disclosure includes the backlight unit according to the present disclosure, described above, the visibility of defects on the recess formation surface of the light diffusion sheet can be suppressed while improving the brightness and the brightness uniformity.

An information device according to the present disclosure includes the liquid crystal display device according to the present disclosure, described above.

Since the information device according to the present disclosure includes the liquid crystal display device according to the present disclosure, described above, the visibility of defects on the recess formation surface of the light diffusion sheet can be suppressed while improving the brightness and the brightness uniformity.

A stacked light diffusion sheet according to the present disclosure includes the light diffusion sheet according to the present disclosure, described above, and another light diffusion sheet adhered to the light diffusion sheet with the flattening printed layer therebetween.

With the stacked light diffusion sheet according to the present disclosure, the following effects can be obtained in addition to similar effects to those of the light diffusion sheet of the present disclosure, described above. That is, by adhering the light diffusion sheets together, the risk of damaging the light diffusion sheets can be reduced, enabling an improvement in yield, in comparison with a case in which the plurality of light diffusion sheets are handled individually, and moreover, the time required to assemble the liquid crystal display device can be reduced, enabling an improvement in throughput.

Note that in the light diffusion sheet according to the present disclosure, described above, the flattening printed layer is formed by printing the light-transmitting ink on the second surface, but instead, a flattening layer constituted by a light-transmitting resin may be formed by a method other than printing so as to cover the irregularities on the second surface, or in other words the matte surface.

### Advantageous Effects of Invention

According to the present disclosure, it is possible to provide a light diffusion sheet capable of suppressing the visibility of defects on a recess formation surface provided with a plurality of inverted substantially polygonal pyramid-shaped recesses, as well as a backlight unit, a liquid crystal display device, an information device, and a stacked light diffusion sheet using the light diffusion sheet.

### BRIEF DESCRIPTION OF DRAWINGS

FIG. 1 is a cross-sectional view of a liquid crystal display device according to an embodiment.

FIG. 2 is a cross-sectional view of a backlight unit according to the embodiment.

FIG. 3 is a view showing a first example of a cross-sectional configuration of a light diffusion sheet used in the backlight unit according to the embodiment.

FIG. 4 is a view showing a second example of the cross-sectional configuration of the light diffusion sheet used in the backlight unit according to the embodiment.

FIG. 5 is a view showing a third example of the cross-sectional configuration of the light diffusion sheet used in the backlight unit according to the embodiment.

FIG. 6 is a perspective view showing the light diffusion sheet according to the embodiment from a surface on which inverted pyramid-shaped recesses are provided.

FIG. 7 is a view showing a planar configuration and a cross-sectional configuration of the inverted pyramid-shaped recess provided in the light diffusion sheet according to the embodiment.

FIG. 8 is a view showing a relationship between an arrangement direction of light sources and an arrangement direction of the inverted pyramid-shaped recesses on the light diffusion sheet in the backlight unit according to the embodiment, wherein (a) shows an arrangement of the light sources and (b) shows an arrangement of the inverted pyramid-shaped recesses.
FIG. 9 is a cross-sectional view of a backlight unit according to an example.

FIG. 10 is a view showing an example cross-sectional configuration of a stacked light diffusion sheet according to another embodiment.

### DESCRIPTION OF EMBODIMENTS

### Embodiment

A light diffusion sheet, a backlight unit, a liquid crystal display device, an information device, and a stacked light diffusion sheet according to an embodiment will be described below with reference to the figures. It should be noted that the scope of the present disclosure is not limited to the embodiment described below, and any modifications can be made without departing from the scope of the technical concept of the present disclosure.

### <Liquid Crystal Display Device>

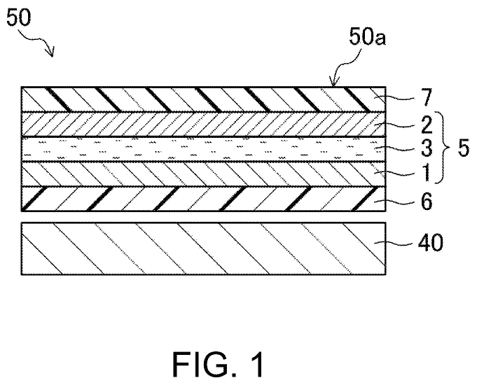

FIG. 1 shows an example of a cross-sectional configuration of a liquid crystal display device according to this embodiment.

As shown in FIG. 1, a liquid crystal display device 50 includes a liquid crystal display panel 5, a first polarizing plate 6 adhered to a bottom surface of the liquid crystal display panel 5, a second polarizing plate 7 adhered to a top surface of the liquid crystal display panel 5, and a backlight unit 40 provided on a back surface side of the liquid crystal display panel 5 via the first polarizing plate 6. The liquid crystal display panel 5 includes a TFT substrate 1 and a CF substrate 2 provided so as to face each other, and a liquid crystal layer 3 provided between the TFT substrate 1 and the CF substrate 2.

The shape of a display screen 50a of the liquid crystal display device 50 as seen from the front (above in FIG. 1) is generally rectangular or square, but is not limited thereto, and may be any desired shape, such as a rectangular shape with rounded corners, an elliptical, circular, or trapezoidal shape, or the shape of an instrument panel of an automobile.

In the liquid crystal display device 50, a voltage of a predetermined magnitude is applied to the liquid crystal layer 3 in each sub-pixel corresponding to each pixel electrode in order to change the alignment state of the liquid crystal layer 3. Thus, the transmittance of light that enters from the backlight unit 40 through the first polarizing plate 6 is adjusted. The light having the adjusted transmittance is emitted through the second polarizing plate 7, whereby an image is displayed.

The liquid crystal display device 50 according to this embodiment is used as a display device incorporated into any of various information devices (for example, an in-vehicle device for car navigation or the like, a personal computer, a mobile phone, a portable information terminal, a portable game machine, a copy machine, a ticket vending machine, or an automated teller machine).

For example, the TFT substrate 1 includes a plurality of TFTs provided in a matrix pattern on a glass substrate, an interlayer insulating film provided so as to cover the TFTs, a plurality of pixel electrodes provided in a matrix pattern on the interlayer insulating film and respectively connected to the plurality of TFTs, and an alignment film provided so as to cover the pixel electrodes. For example, the CF substrate 2 includes a black matrix provided in a grid pattern on a glass substrate, a color filter including a red layer, a green layer, and a blue layer respectively provided between the grids of the black matrix, a common electrode provided so as to cover the black matrix and the color filter, and an alignment film provided so as to cover the common electrode. The liquid crystal layer 3 is constituted by a nematic liquid crystal material or the like containing liquid crystal molecules with electro-optic characteristics. For example, the first polarizing plate 6 and the second polarizing plate 7 include a polarizer layer with a polarization axis in one direction, and a pair of protective layers provided so as to sandwich the polarizer layer.

### <Backlight Unit>

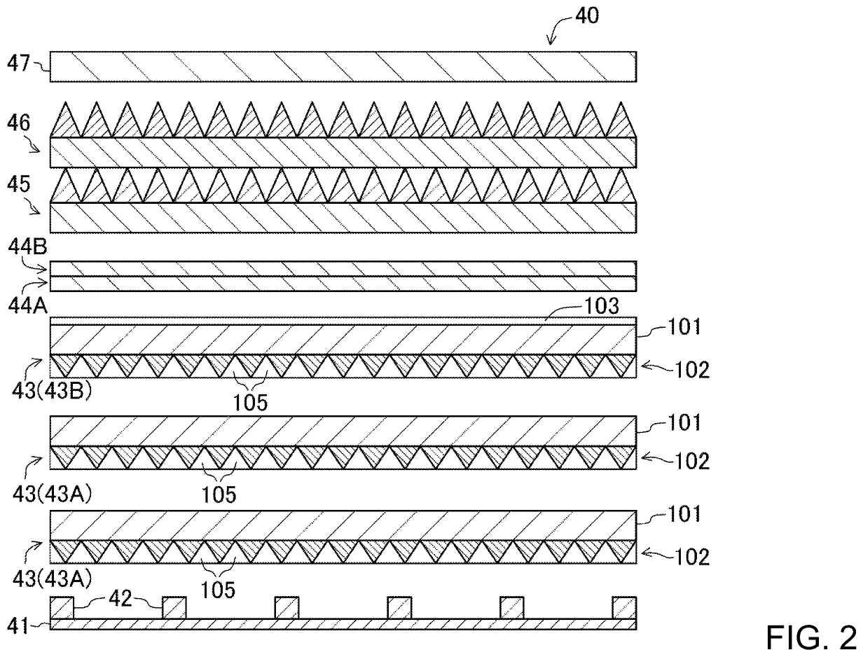

FIG. 2 shows an example of a cross-sectional configuration of the backlight unit according to this embodiment.

As shown in FIG. 2, the backlight unit 40 mainly includes a plurality of light sources 42 and a light diffusion sheet 43 provided on the upper side of the plurality of light sources 42. The plurality of light sources 42 may be deployed two-dimensionally on a reflective sheet 41. The plurality of light sources 42 may be, for example, white light sources or blue light sources. A plurality of light diffusion sheets 43 may be deployed. In this example, the light diffusion sheet 43 includes two first light diffusion sheets 43A deployed on the upper side of the plurality of light sources 42, and a second light diffusion sheet 43B deployed on the upper side of the first light diffusion sheets 43A. The first light diffusion sheets 43A and the second light diffusion sheet 43B each include a base material layer 101 and a light diffusion layer 102 provided on the base material layer 101. In this example, the light diffusion layer 102 is provided so as to face the direction of the light sources 42 (in other words, on the light entrance surface), and a plurality of recesses 105 having an inverted substantially polygonal pyramid shape, or more specifically an inverted substantially square pyramid shape (also referred to hereinafter as an inverted pyramid shape) are provided on the light diffusion layer 102. Meanwhile, the surface of the base material layer 101 that serves as the light emission surface is a matte surface, and the matte surface is exposed on each of the first light diffusion sheets 43A, while a flattening printed layer 103 is provided so as to cover the matte surface on the second light diffusion sheet 43B.

A wavelength selection sheet 44A and a color conversion sheet 44B may be deployed on the upper side of the second light diffusion sheet 43B. The wavelength selection sheet 44A is deployed on the lower side of the color conversion sheet 44B. The wavelength selection sheet 44A selectively transmits light having the emission wavelength of the light sources 42 and reflects light having other wavelengths. The color conversion sheet 44B converts the color of the light emitted by the light sources 42.

A first prism sheet 45 and a second prism sheet 46 may be deployed in that order on the upper side of the color conversion sheet 44B to enhance the brightness. A brightness-enhancing sheet 47 such as a one-way reflective polarizing film, for example, may be additionally deployed on the upper side of the second prism sheet 46 to further enhance the brightness.

### [Reflective Sheet]

The reflective sheet 41 is constituted by a white polyethylene terephthalate resin film, a silver vapor-deposited film, or the like, for example.

### [Light Sources]

The type of the light sources 42 is not particularly limited, and the light sources 42 may be LED elements, laser elements, or the like, for example. From the viewpoints of cost, productivity, and so on, LED elements may be used. The light sources 42 may have a rectangular shape when seen in plan view, and in this case, the length of one side may be 10 μm or more (preferably 50 μm or more) and 20 mm or less (preferably 10 mm or less, and more preferably 5 mm or less). When LEDs are used as the light sources 42, a plurality of LED chips may be deployed at fixed intervals on the reflective sheet 41. A lens may be mounted on the LEDs serving as the light sources 42 in order to adjust the emission angle characteristic of the LED. While the number of deployed light sources 42 is also not particularly limited, when the plurality of light sources 42 are deployed in a distributed manner, the light sources 42 are preferably deployed regularly on the reflective sheet 41. Regularly deployed means deployed with a fixed regularity, and for example corresponds to a case in which the light sources 42 are deployed at equal intervals. When the light sources 42 are deployed at equal intervals, a center-to-center distance between two adjacent light sources 42 may be 0.5 mm or more (preferably

### [Light Diffusion Sheet]

The light diffusion sheet 43 diffuses light rays entering from the light sources 42 and collects the light rays on a normal direction side (in other words, collects and diffuses the light). FIG. 2 shows an example of a case in which the two first light diffusion sheets 43A and the one second light diffusion sheet 43B are provided in the backlight unit 40 as the light diffusion sheet 43, but the light diffusion sheet 43 may be constituted by the one second light diffusion sheet 43B alone, or by two, four, or more sheets including at least one second light diffusion sheet 43B. The matrix resin constituting the light diffusion sheet 43 is not particularly limited as long as the matrix resin is constituted by a material that transmits light, and for example, the matrix resin may be polycarbonate, acrylic, polystyrene, MS (methyl methacrylate-styrene copolymer) resin, polyethylene terephthalate, polyethylene naphthalate, cellulose acetate, polyimide, and so on. The thickness of the light diffusion sheet 43 is also not particularly limited, but may be 50 μm or more and 3 mm or less, for example. When the thickness of the light diffusion sheet 43 exceeds 3 mm, it becomes more difficult to achieve a reduction in the thickness of the liquid crystal display, whereas when the thickness of the light diffusion sheet 43 falls below 50 μm, it becomes difficult to obtain a sufficient light diffusion effect. When a plurality of light diffusion sheets 43 are used, as shown in FIG. 2, the total thickness may be around several hundred μm to several mm. The light diffusion sheet 43 may also be in the form of a film or a plate. The configuration of the light diffusion sheet 43 and a manufacturing method therefor will be described in detail later.

### [Wavelength Selection Sheet and Color Conversion Sheet]

The wavelength selection sheet 44A selectively transmits light having the emission wavelength of the light sources 42 (for example, blue light) and reflects light of other wavelengths. The color conversion sheet 44B converts the light (for example, blue light) from the light sources 42 into light having a wavelength of a desired color (for example, green or red) as a peak wavelength. For example, the color conversion sheet 44B converts blue light having a wavelength of 450 nm into green light having a wavelength of 540 nm and red light having a wavelength of 650 nm. In this case, when light sources 42 that emit blue light having a wavelength of 450 nm are used, the blue light is partially converted into green light and red light by the color conversion sheet 44B, whereby the light transmitted through the color conversion sheet 44B becomes white light. A QD (quantum dot) sheet, a fluorescent sheet, or the like, for example, may be used as the color conversion sheet 44B. Since the wavelength selection sheet 44A is deployed on the lower side of the color conversion sheet 44B, light having a wavelength that has been changed by the color conversion sheet 44B can only advance upward from the color conversion sheet 44B.

The wavelength selection sheet 44A and the color conversion sheet 44B can be deployed in any position between the light sources 42 and the first prism sheet 45. For example, the wavelength selection sheet 44A and the color conversion sheet 44B may be deployed between the light sources 42 and the first light diffusion sheet 43A or between the first light diffusion sheet 43A and the second light diffusion sheet 43B. When white light sources are used as the light sources 42, the wavelength selection sheet 44A and the color conversion sheet 44B may be omitted.

### [Prism Sheets]

The first prism sheet 45 and the second prism sheet 46 refract light rays entering from the light diffusion sheet 43 in a normal direction. For example, a plurality of groove lines with an isosceles triangle-shaped cross-section are provided adjacent to each other on the respective light emission surfaces of the prism sheets 45 and 46, and prisms are formed by triangular column parts sandwiched between adjacent pairs of groove lines. The apex angle of the prism is around 90°, for example. The groove lines formed in the first prism sheet 45 and the groove lines formed in the second prism sheet 46 may be deployed so as to be orthogonal to each other. Thus, light rays entering from the light diffusion sheet 43 can be refracted in the normal direction by the first prism sheet 45, and light rays emitted from the first prism sheet 45 can be refracted by the second prism sheet 45 so as to advance substantially perpendicularly to the light entrance surface of the brightness-enhancing sheet 47. The prism sheets 45 and 46 may be stacked as separate bodies or may be formed integrally. The total thickness of the prism sheets 45 and 46 may be around 100-400 μm, for example. A PET (polyethylene terephthalate) film in which prism shapes are formed using a UV-curable acrylic resin, for example, may be used as the prism sheets 45 and 46.

### [Brightness-Enhancing Sheet]

The brightness-enhancing sheet 47 may increase the brightness by consolidating the light rays using double reflection and the refractive index of the light as the light passes through the sheet. Alternatively, the brightness-enhancing sheet 47 may increase the brightness by recycling an S-wave that does not pass through the first polarizing plate 6 of the liquid crystal display device 50 and converting the recycled S-wave into a P-wave that passes through the first polarizing plate 6. When a sufficient brightness enhancing effect is obtained by the prism sheets 45 and 46, the brightness-enhancing sheet 47 may be omitted.

### <Configuration of Light Diffusion Sheet>

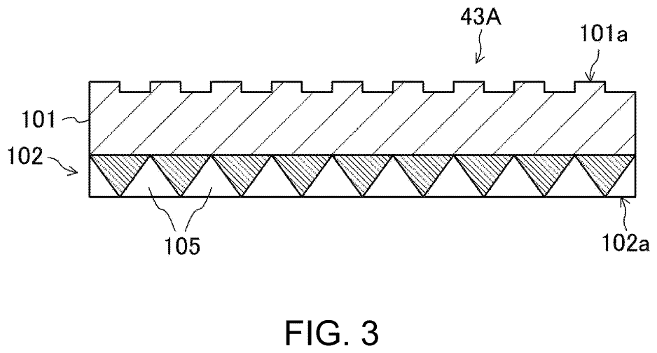

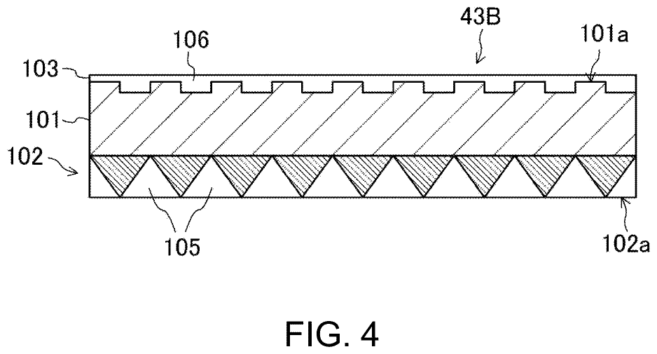

As shown in FIGS. 3 and 4, each of the first light diffusion sheets 43A and the second light diffusion sheet 43B mainly includes a base material layer 101 and a light diffusion layer 102 provided on the base material layer 101. Each of the light diffusion sheets 43A and 43B has a first surface (the front surface of the light diffusion layer 102) 102a that serves as the light entrance surface, and a second surface (the front surface of the base material layer 101) 101a that serves as the light emission surface. The plurality of recesses 105 having an inverted substantially polygonal pyramid shape, or more specifically an inverted substantially square pyramid shape (an inverted pyramid shape) are provided on the light diffusion layer 102 in order to diffuse light. The second surface 101a of each of the light diffusion sheets 43A and 43B is a matte surface. The matte surface is a fine roughened surface having a surface roughness of around 1-10 μm. The irregularities on the matte surface may be provided randomly. Note that in the present disclosure, the surface roughness refers to the arithmetic mean roughness Ra according to JIS B 0601-1994.

Note that in this example, the first surface 102a of each of the light diffusion sheets 43A and 43B is used as the light entrance surface, and the second surface 101a is used as the light emission surface, but instead, the first surface 102a may be the light emission surface and the second surface 101a may be the light entrance surface. Alternatively, the plurality of light diffusion sheets 43 may include both a sheet on which the first surface 102a is the light entrance surface and the second surface 101a is the light emission surface, and a sheet on which the first surface 102a is the light emission surface and the second surface 101a is the light entrance surface.

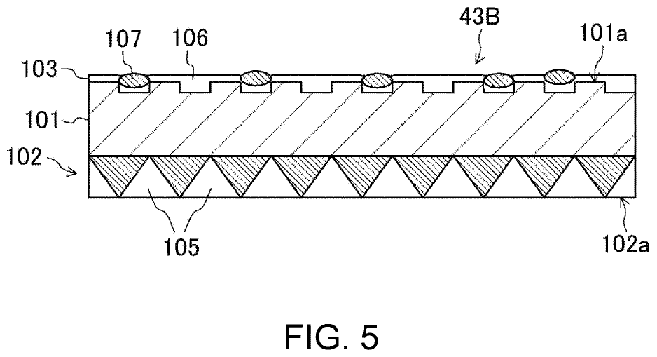

On the first light diffusion sheet 43A, as shown in FIG. 3, the second surface 101a, i. e., the matte surface, is exposed. Meanwhile, as shown in FIG. 4, the second light diffusion sheet 43B is provided with a flattening printed layer 103 constituted by, for example, an acrylic urethane-based light-transmitting ink 106 so as to cover the irregularities on the second surface 101a, i.e., the matte surface. Note that the surface roughness of the second surface (matte surface) 101a of the second light diffusion sheet 43B provided with the flattening printed layer 103 is preferably 1 μm or more and 6 μm or less, more preferably 2 μm or more and 5 μm or less, and even more preferably 2.8 μm or more and 4 μm or less. Furthermore, as long as the second surface (matte surface) 101a has a ten-point average roughness Rz (according to JIS B 0601-1994) of around 50 μm or less, the irregularities on the second surface 101a can be covered and flattened by being printed with the light-transmitting ink 106. Moreover, as shown in FIG. 5, a plurality of acrylic particles (hereinafter, also referred to as beads) 107, for example, may be added to the flattening printed layer 103.

### [Base Material Layer]

The base material layer 101 of each of the light diffusion sheets 43A and 43B is required to transmit light rays, and is therefore formed using a transparent (for example, colorless and transparent) synthetic resin as the main component. The main component of the base material layer 101 is not particularly limited, and for example, polycarbonate, polyethylene terephthalate, polyethylene naphthalate, acrylic resin, polystyrene, polyolefin, cellulose acetate, weather-resistant vinyl chloride, or the like may be used. Note that the term “main component” refers to the component having the highest content, for example, a component having a content of 50% by mass or more. The base material layer 101 may contain a diffusing agent or other additives, or may be substantially free of additives. The additives that may be included are not particularly limited, but may be inorganic particles of silica, titanium oxide, aluminum hydroxide, barium sulfate, and so on, for example, or organic particles of acrylic, acrylonitrile, silicone, polystyrene, polyamide, and so on, for example.

The lower limit of the average thickness of the base material layer 101 is preferably around 10 μm, more preferably around 35 μm, and even more preferably around 50 μm. The upper limit of the average thickness of the base material layer 101 is preferably around 500 μm, more preferably around 250 μm, and even more preferably around 180 μm due to the risk of curling. Conversely, when the average thickness of the base material layer 101 exceeds the upper limit, the brightness of the liquid crystal display device 50 may decrease, and it may become difficult to respond to demand to make the liquid crystal display device 50 thin. Note that in the present disclosure, the term “average thickness” refers to an average value of the thickness at any ten points.

The light diffusion layer 102 of each of the light diffusion sheets 43A and 43B is required to transmit light rays, and is therefore formed using a transparent (for example, colorless and transparent) synthetic resin as the main component. The light diffusion layer 102 may be molded integrally with the base material layer 101 during extrusion molding of a base material resin forming the base material layer 101, or may be molded separately using a UV-curable resin after molding the base material layer 101.

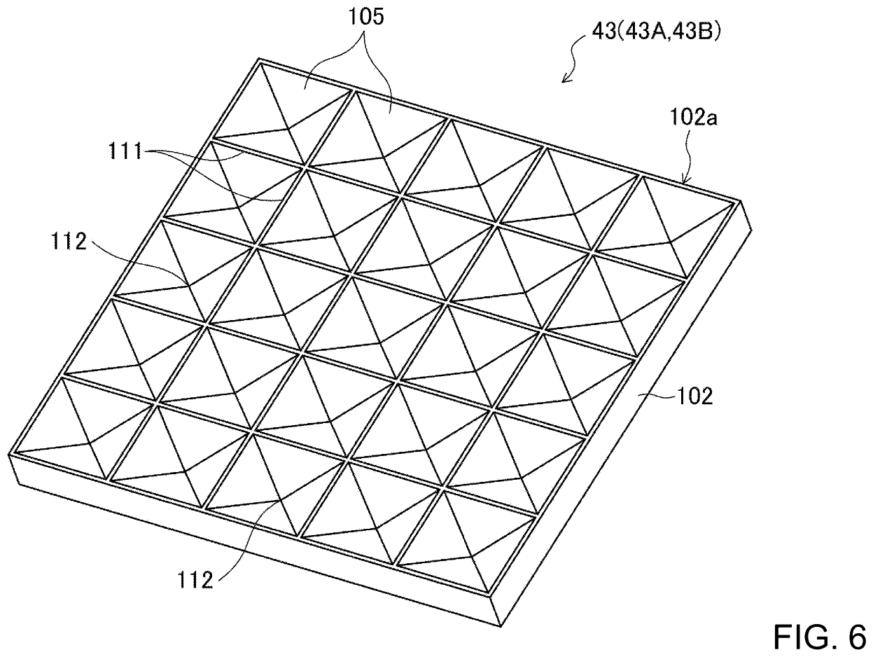

As shown in FIG. 6, for example, the plurality of inverted substantially square pyramid-shaped (inverted pyramid-shaped) recesses 105 provided on the light diffusion layer 102 may be arranged in a two-dimensional matrix pattern. In other words, the plurality of recesses 105 may be arranged along two mutually orthogonal directions. Adjacent recesses 105 are partitioned by ridge lines 111. The ridge lines 111 extend along the two directions in which the recesses 105 are arranged. The arrangement pitch of the recesses 105 may be, for example, around 50 μm or more and around 500 μm or less. A center (the apex of the inverted pyramid) 112 of the recess 105 is the deepest portion of the recess 105. The center (the deepest portion) 112 of the recess 105 may reach the front surface of the base material layer 101 (the light emission surface). In other words, the depth of the recess 105 may be set to be equal to the thickness of the light diffusion layer 102. Note that although FIG. 6 illustrates a state in which the recesses 105 are deployed in a 5×5 matrix pattern for the sake of simplicity, the actual number of arranged recesses 105 is significantly larger.

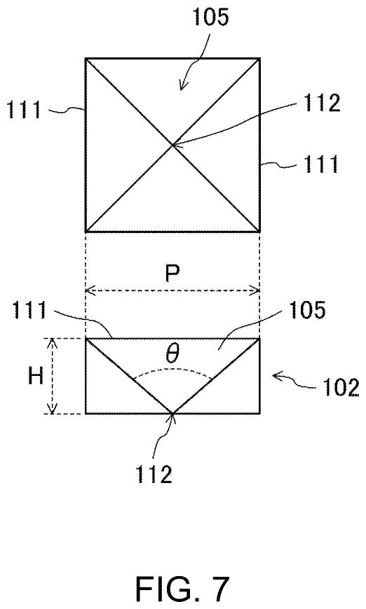

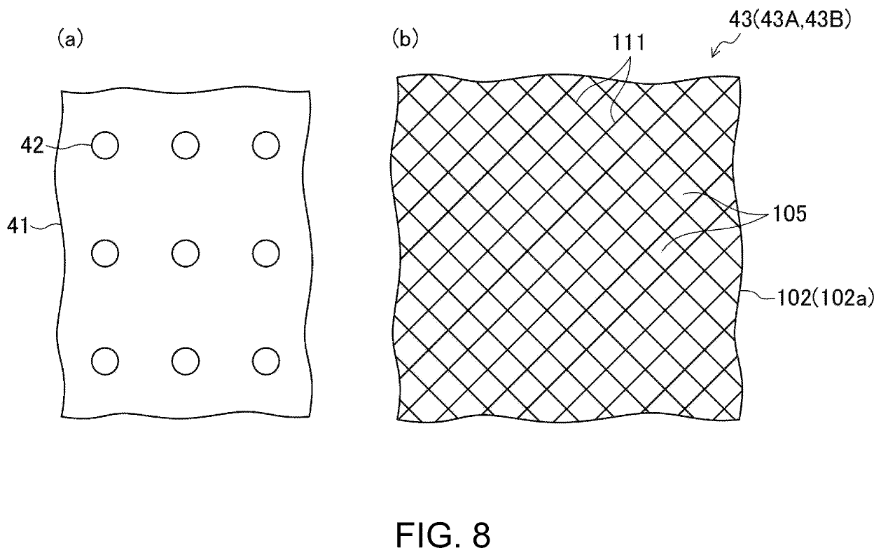

The apex angle θ of the recess 105 is set at around 90°, for example. As shown in FIG. 7, the apex angle θ of the recess 105 is an angle formed by inclined surfaces of the recess 105 in a cross-section (the lower diagram in FIG. 7) that appears when the recess 105 is cut so as to perpendicularly cross a pair of ridge lines 111 that pass through the apex 112 of the inverted pyramid and face each other across the apex 112 in a plane (a vertical cross-section) that is perpendicular to the placement surface (a horizontal plane) of the light diffusion sheet 43.

Note that the upper diagram of FIG. 7 shows the planar configuration of the recess 105. Furthermore, in FIG. 7, “H” denotes the depth of the recess 105 (the height of the pyramid shape), and “P” denotes the horizontal width of the recess 105 (in other words, the arrangement pitch of the recesses 105). The depth H of the recess 105 is determined by the arrangement pitch P of the recesses 105 and the apex angle θ of the recess 105.

When the plurality of light sources 42 are arranged in a square shape, as shown in (a) of FIG. 8, the arrangement direction of the recesses 105 may be inclined by around 45°, for example, as shown in (b) of FIG. 8, relative to the arrangement direction of the light sources 42. When the recesses 105 are formed in an inverted pyramid shape, by setting the arrangement direction of the light sources 42 and the arrangement direction of the recesses 105 to intersect, the brightness uniformity can be improved more than when the two arrangement directions are aligned.

Although in this embodiment, the inverted pyramid-shaped (inverted substantially square pyramid-shaped) recesses 105 are arranged in a two-dimensional matrix pattern so as to form an uneven shape, the recesses 105 may be arranged randomly as long as the actions and effects of the present invention are not lost. When the recesses 105 are regularly arranged in a two-dimensional arrangement, gaps may be provided between the recesses 105, but do not have to be provided. The recesses 105 may have an inverted substantially polygonal pyramid shape other than an inverted substantially square pyramid shape. For example, the “inverted polygonal pyramid” shape of the recess 105 may be an inverted triangular pyramid or an inverted hexagonal pyramid that can be deployed two-dimensionally without gaps, similarly to an inverted square pyramid. When the “inverted polygonal pyramid” shape of the recess 105 is an inverted square pyramid, it is easy to improve the accuracy of a surface cutting operation of a metal mold (a metal roll) used in a manufacturing process such as extrusion molding or injection molding performed when providing the recesses 105.

While the term “inverted substantially polygonal pyramid” is used in the present disclosure in consideration of the fact that it is difficult to form geometrically strict inverted polygonal pyramid-shaped recesses using ordinary shape transfer techniques, it is assumed that the term “inverted substantially polygonal pyramid” includes shapes that can be regarded as an inverted truly or substantially polygonal pyramid. In addition, the term “substantially” means “can be approximated” such that, for example, an “inverted substantially square pyramid” refers to a shape that can approximate an inverted square pyramid. For example, likewise with regard to an “inverted polygonal truncated pyramid” having a flat top, as long as the actions and effects of the present invention are not lost, a shape having a small top area is also assumed to be included as an “inverted substantially polygonal pyramid”. Furthermore, shapes that are deformed from an “inverted polygonal pyramid” within the range of inevitable shape variability due to machining accuracy in industrial production are also assumed to be included as an “inverted substantially polygonal pyramid”.

### [Flattening Printed Layer]

In this embodiment, the flattening printed layer 103 is constituted by the light-transmitting ink 106, which is provided to cover the second surface 101a of the second light diffusion sheet 43B, or in other words the irregularities of the matte surface. The flattening printed layer 103 is formed, for example, by solid-printing the light-transmitting ink 106 onto the second surface 101a. By providing the flattening printed layer 103, the brightness and brightness uniformity are improved as compared with the case where the second surface 101a of the second light diffusion sheet 43B, i.e., the matte surface, is exposed.

Note that the surface roughness of the flattening printed layer 103 is not particularly limited as long as it is smaller than the surface roughness of the second surface 101a of the second light diffusion sheet 43B, i. e., the matte surface. However, the surface roughness of the flattening printed layer 103 is preferably less than 1 μm, more preferably 0.1 μm or less, and even more preferably 0.01 μm or less.

Further, the thickness of the flattening printed layer 103 is not particularly limited as long as the irregularities on the second surface 101a of the second light diffusion sheet 43B, i.e., the matte surface, can be covered thereby. However, the thickness of the flattening printed layer 103 is preferably 5 μm or more, and more preferably 8 μm or more. In order to suppress an increase in thickness of the second light diffusion sheet 43B, on the other hand, the thickness of the flattening printed layer 103 is preferably no more than 20 μm, and more preferably no more than 15 μm. Note that in the present disclosure, the thickness of the flattening printed layer 103 refers to the “average thickness”, and is substantially equal to the thickness when the light-transmitting ink 106 constituting the flattening printed layer 103 is solid-printed on a flat surface.

The material of the light-transmitting ink 106 constituting the flattening printed layer 103 is not particularly limited as long as it can transmit light, and for example, acrylic, polyester, vinyl, urethane acrylate, silicone, cellulose, epoxy, phenol, and so on may be used. The light-transmitting ink 106, rather than being liquid ink, is solid ink that is formed from a material such as a thermosetting resin or a thermoplastic resin and has a light-transmitting property.

As regards the particles 107 added to the flattening printed layer 103 (see FIG. 5), the material, shape, dimensions, etc. thereof are not particularly limited as long as the particles 107 can diffuse or reflect light. The material of the particles 107 may be, for example, acrylic, styrene, titanium, silica, nylon, urethane, or the like. The particles 107 may be mono-dispersed or poly-dispersed. The particles 107 may have a hollow structure. In this case, the particles 107 may be single-hollow or multi-hollow particles.

The shape of the particles 107 may be a bead shape such as, for example, acrylic beads, or a fibrous shape such as, for example, cellulose nanofibers. In order to suppress problems occurring when the second light diffusion sheet 43B is wound onto a roll, such as an interference pattern, a press-bonding mark, or the like remaining on the flattening printed layer 103, or the formation surface of the recesses 105 (the first surface 102a) and the surface of the flattening printed layer 103 sticking together so as to cause scratches when the surfaces are peeled apart, the average particle size of the particles 107 may be set to be larger than the average thickness of the flattening printed layer 103. Thus, the particles 107 are more likely to be exposed from the surface of the flattening printed layer 103, and as a result, the aforementioned problems are less likely to occur. Note, however, that in order to prevent the particles 107 from falling off the flattening printed layer 103, the average particle size of the particles 107 is preferably around several μm (around 1-5 μm) larger than the average thickness of the flattening printed layer 103. In the present disclosure, the average particle size of the particles 107 refers to the average diameter when the particles 107 are bead-shaped and the average length when the particles 107 are fibrous.

The mass ratio of the particles 107 to the light-transmitting ink 106 in the flattening printed layer 103 is not particularly limited as long as the occurrence of the aforementioned problems, that is, the occurrence of scratches and sticking during manufacture of the second light diffusion sheet 43B, can be suppressed. Note, however, that in order to suppress the occurrence of scratches and sticking while suppressing reductions in the brightness and brightness uniformity, the mass ratio of the particles 107 is preferably 1% or more and 10% or less, more preferably 2% or more and 8% or less, and even more preferably 4% or more and 6% or less.

When the particles 107 are added to the light-transmitting ink 106, for example, the light-transmitting ink 106, which is a thermosetting resin, a UV-curable resin, or the like, may be printed after dispersing the particles 107 through the light-transmitting ink 106, whereupon the light-transmitting ink 106 may be cured by ultraviolet rays or hot air. The method for printing the light-transmitting ink 106 is not particularly limited, and may be, for example, screen printing, gravure printing, or the like, which are included in the category of analog printing, inkjet printing, laser printing, or the like, which are included in the category of digital printing, hybrid printing combining both analog and digital printing methods, or the like.

### <Method for Manufacturing Light Diffusion Sheet>

The method for manufacturing the light diffusion sheet 43 including the second light diffusion sheet 43B is not particularly limited, and for example, the light diffusion sheet 43 can be manufactured using any of the following manufacturing methods.

In a first manufacturing method, first, a pellet-form base material resin (plastic resin) is formed into a resin film by an extrusion molding machine. Next, using a roll having convex pyramid shapes on the surface thereof as one of two metal rolls and using a roll having an inverted shape of a matte surface on the surface thereof as the other roll, the light diffusion sheet 43 having inverted pyramid shapes (the recesses 105) on one surface and a matte surface on the other surface is manufactured by pressing the two rolls against the resin film. In this manufacturing method, the base material layer 101 and the light diffusion layer 102 are formed integrally. The flattening printed layer 103 is then formed on the matte surface of the second light diffusion sheet 43B.

In a second manufacturing method, first, the base material layer 101 having polyethylene terephthalate, for example, as the main component is prepared. While feeding the base material layer 101 between a pair of pressing rolls, a UV-curable resin (a resin composition for forming protrusions) is supplied to one surface of the base material layer 101 immediately before the pair of pressing rolls. A pressing roll having a plurality of substantially square pyramid-shaped protrusions on the outer peripheral surface thereof is used as the pressing roll on the side that comes into contact with the UV-curable resin, and a roll having an inverted shape of a matte surface on the surface thereof is used as the other roll. After pressing the pair of pressing rolls against the base material layer 101 to which the UV-curable resin has been supplied, the UV-curable resin is cured by UV irradiation, whereby a plurality of inverted pyramid shapes (the recesses 105), which are inverted shapes of the plurality of substantially square pyramid-shaped protrusions, are transferred, and as a result, the light diffusion sheet 43 with the light diffusion layer 102 provided on one surface of the base material layer 101 and a matte surface on the other surface is manufactured. In this manufacturing method, the base material layer 101 and the light diffusion layer 102 are formed separately. The flattening printed layer 103 is then formed on the matte surface of the second light diffusion sheet 43B.

### <Features of Embodiment>

The second light diffusion sheet 43B of this embodiment is the light diffusion sheet 43 having the plurality of inverted substantially polygonal pyramid-shaped recesses 105 provided on the first surface 102a serving as the light emission surface or the light entrance surface. The second surface 101a on the opposite side to the first surface 102a is a matte surface, and the flattening printed layer 103 constituted by the light-transmitting ink 106 is provided so as to cover the irregularities on the matte surface.

According to the second light diffusion sheet 43B of this embodiment, the visibility of defects on the first surface 102a (the recess formation surface) provided with the inverted substantially polygonal pyramid-shaped recesses 105 can be suppressed by the matte surface shape of the second surface 101a. Moreover, since the flattening printed layer 103 is provided so as to cover the second surface 101a, i.e., the matte surface, the brightness and brightness uniformity can be improved as compared with a case in which the second surface 101a, i.e., the matte surface, is exposed.

In the second light diffusion sheet 43B of this embodiment, the thickness of the flattening printed layer 103 may be 5 μm or more. Thus, even a matte surface (the second surface 101a) having a comparatively large surface roughness can be flattened by the flattening printed layer 103.

In the second light diffusion sheet 43B of this embodiment, the plurality of particles 107 may be added to the flattening printed layer 103. Thus, scratches, sticking and so on are less likely to occur during manufacture of the second light diffusion sheet 43B. For example, when the second light diffusion sheet 43B is wound onto a roll, the occurrence of problems such as an interference pattern, a press-bonding mark, or the like remaining on the surface (the printed surface) of the flattening printed layer 103 or the formation surface of the recesses 105 (the first surface 102a) and the printed surface sticking together so as to cause scratches when the surfaces are peeled apart can be suppressed. As a result, mass productivity can be improved.

In the second light diffusion sheet 43B of this embodiment, the average particle size of the plurality of particles 107 may be greater than the thickness (the average thickness) of the flattening printed layer 103. Thus, scratches, sticking, and the like are even less likely to occur during manufacture of the second light diffusion sheet 43B.

In the second light diffusion sheet 43B of this embodiment, the mass ratio of the particles 107 to the light-transmitting ink 106 in the flattening printed layer 103 may be 1% or more and 10% or less. Thus, the occurrence of scratches and sticking during manufacture of the second light diffusion sheet 43B can be suppressed while suppressing reductions in the brightness and brightness uniformity.

In the second light diffusion sheet 43B of this embodiment, the plurality of recesses 105 may be formed in an inverted substantially square pyramid shape and arranged in a two-dimensional matrix pattern. Thus, the second light diffusion sheet 43B can be manufactured with high accuracy so as to exhibit excellent brightness uniformity.

In the second light diffusion sheet 43B of this embodiment, as long as the matte surface (the second surface 101a) has a ten-point average roughness Rz (based on JIS B 0601-1994) of around 50 μm or less, the irregularities on the second surface 101a can be covered and flattened by printing the light-transmitting ink 106.

The backlight unit 40 according to this embodiment is incorporated into the liquid crystal display device 50 in order to guide the light emitted from the plurality of light sources 42 toward the display screen 50a. The backlight unit 40 includes the second light diffusion sheet 43B of this embodiment, which is provided between the display screen 50a and the light sources 42. Thus, the visibility of defects on the formation surface of the recesses 105 (the first surface 102a) on the second light diffusion sheet 43B can be suppressed while improving the brightness and the brightness uniformity. Note that in the backlight unit 40, the effect of suppressing the visibility of defects is greater when the second light diffusion sheet 43B is deployed with the first surface 102a as the light entrance surface.

In the backlight unit 40 of this embodiment, the plurality of light sources 42 may be deployed on the reflective sheet 41 provided on the opposite side to the display screen 50a as seen from the light diffusion sheet 43. Thus, the light is further diffused by multiple reflection between the light diffusion sheet 43 and the reflective sheet 41, leading to a further improvement in the brightness uniformity.

In the backlight unit 40 according to this embodiment, the plurality of light diffusion sheets 43 including the second light diffusion sheet 43B may be deployed between the display screen 50a and the plurality of light sources 42. Thus, the plurality of light diffusion sheets 43 can be used to further improve the brightness uniformity. In this case, the effect of suppressing the visibility of defects is greater when the second light diffusion sheet 43B is deployed at the top.

The liquid crystal display device 50 according to this embodiment includes the backlight unit 40 of this embodiment and the liquid crystal display panel 5. Thus, the visibility of defects on the formation surface of the recesses 105 (the first surface 102a) on the second light diffusion sheet 43B can be suppressed while improving the brightness and the brightness uniformity. A similar effect can be obtained in an information device (a personal computer, a mobile phone, or the like) into which the liquid crystal display device 50 of this embodiment is incorporated.

It should be noted that in this embodiment, a direct-type backlight unit in which the plurality of light sources 42 are deployed in a distributed manner on the back surface side of the display screen 50a of the liquid crystal display device 50 is used as the backlight unit 40. Therefore, in order to reduce the size of the liquid crystal display device 50, it is necessary to reduce the distance between the light sources 42 and the light diffusion sheet 43 (in the example shown in FIG. 2, the first light diffusion sheet 43A closest to the light sources 42). However, when this distance is reduced, a phenomenon (brightness unevenness) whereby the brightness of the display screen 50a in parts located in regions between the distributed light sources 42 decreases in comparison with other parts is more likely to occur. However, using the second light diffusion sheet 43B of this embodiment is useful in suppressing brightness unevenness. More specifically, when the distance between the light sources 42 and the light diffusion sheet 43 (in a case where a plurality of light diffusion sheets 43 are used, the light diffusion sheet 43 closest to the light sources 42) is set at 10 mm or less, preferably 5 mm or less, more preferably 2 mm or less, even more preferably 1 mm or less, and ultimately 0 mm in anticipation of future reductions in the thickness of small and medium-sized liquid crystal displays, it is believed that the usefulness of the second light diffusion sheet 43B of this embodiment will become even more apparent. For example, even when a sufficient distance for achieving a thickness reduction cannot be secured between the light sources and the sheet, such as when the distance between the light sources 42 and the light diffusion sheet 43 is 0 mm or more and 1 mm or less, deterioration of the in-plane brightness uniformity can be suppressed by the light diffusion performance of the second light diffusion sheet 43B of this embodiment.

### EXAMPLES

Examples and a comparative example will be described below.

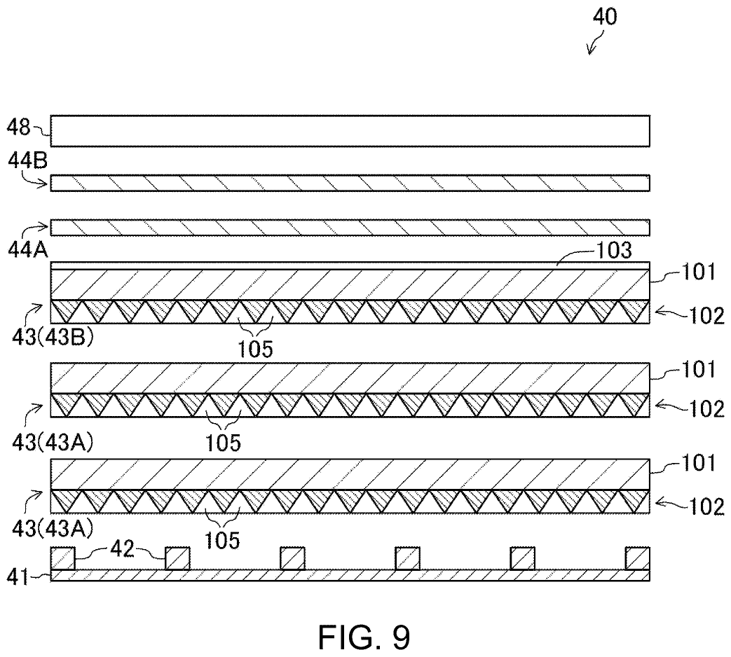

As example 1, a component in which the second light diffusion sheet 43B shown in FIG. 4 was provided in the backlight unit 40 configured as shown in FIG. 9 was prepared. More specifically, the backlight configuration shown in FIG. 9 was obtained by placing a glass plate 48 on the color conversion sheet 44B in the backlight configuration shown in FIG. 2 without providing the prism sheets 45 and 46 and the brightness-enhancing sheet 47. Further, the flattening printed layer 103 having an average thickness of 10 μm was provided by solid-printing the acrylic urethane-based light-transmitting ink 106 so as to cover the irregularities on the matte surface forming the second surface 101a of the second light diffusion sheet 43B.

As example 2, a component in which the second light diffusion sheet 43B shown in FIG. 5 was provided in the backlight unit 40 configured as shown in FIG. 9 was prepared. More specifically, the flattening printed layer 103 having an average thickness of 10 μm was provided by solid-printing the acrylic urethane-based light-transmitting ink 106 with the plurality of particles 107 added thereto so as to cover the irregularities on the matte surface forming the second surface 101a of the second light diffusion sheet 43B. Acrylic beads with an average particle size of 12 μm were used as the particles 107, and were added in a ratio of 5 parts by mass to 100 parts by mass of the light-transmitting ink 106.

As a comparative example, a component in which the flattening printed layer 103 was not provided on the second light diffusion sheet 43B in the backlight unit 40 configured as shown in FIG. 9 was prepared.

In all of examples 1 and 2 and the comparative example, a sheet obtained by providing the light diffusion layer 102, in which the plurality of inverted pyramid-shaped recesses 105 were arranged in a two-dimensional matrix pattern using an acrylate-based UV-curable resin, on the polycarbonate base material layer 101 having a thickness of 110 μm was used as the light diffusion sheet 43 including the second light diffusion sheet 43B. The apex angle and the arrangement pitch of the recesses 105 were 90° and 100 μm, respectively. All of the light diffusion sheets 43 were deployed so that the arrangement direction of the recesses 105 intersected the arrangement direction of the light sources 42 at 45°. A blue LED array arranged in a square shape with a pitch of 3.5 mm×a pitch of 4.5 mm were used as the plurality of light sources 42. The thickness of the wavelength selection sheet 44A was set at 50 μm, and the thickness of the color conversion sheet 44B was set at 60 μm.

In the backlight unit configurations of examples 1 and 2 and the comparative example, described above, the brightness and brightness uniformity were evaluated in the following manner in a state where the transparent glass plate 48 was placed on the color conversion sheet 44B in order to prevent sheet lifting. First, using a two-dimensional color brightness meter SR-5000, manufactured by Topcon Technohouse Corp., the brightness (cd/m²) upward in a vertical direction (a direction traveling from the LED array toward the glass plate) was measured. Next, an obtained two-dimensional brightness distribution image was corrected for variation in the emission intensity of the individual LEDs, filtering processing was executed to suppress bright spot and dark spot noise caused by foreign matter and the like, an average value and a standard deviation were calculated for the brightness of all of the pixels, and the brightness and the brightness uniformity were determined with the “brightness” defined as “average value of brightness” and the “brightness uniformity” defined as “average value of brightness/standard deviation of brightness”.

As a result, the brightness of the comparative example was 6085 cd/m² , while the brightness of examples 1 and 2 was 6173 cd/m² and 6178 cd/m² , respectively. Further, the brightness uniformity of the comparative example was 21.29, while the brightness uniformity of examples 1 and 2 was 21.41 and 21.86, respectively.

As described above, in all of the examples, it was possible to improve the brightness and the brightness uniformity in a configuration with which it is possible to suppress the visibility of defects on the recess formation surface and improve the mass productivity (with regard to improving the mass productivity, only example 2). In other words, the effectiveness of providing the flattening printed layer 103 on the second light diffusion sheet 43B was confirmed.

### Other Embodiments

While an embodiment (including examples; the same applies hereinafter) of the present disclosure was described above, the present disclosure is not solely limited to the embodiment described above, and various modifications can be made within the scope of the disclosure. In other words, the foregoing description of the embodiment is illustrative in nature and is not intended to limit the present disclosure, its applications, or its uses.

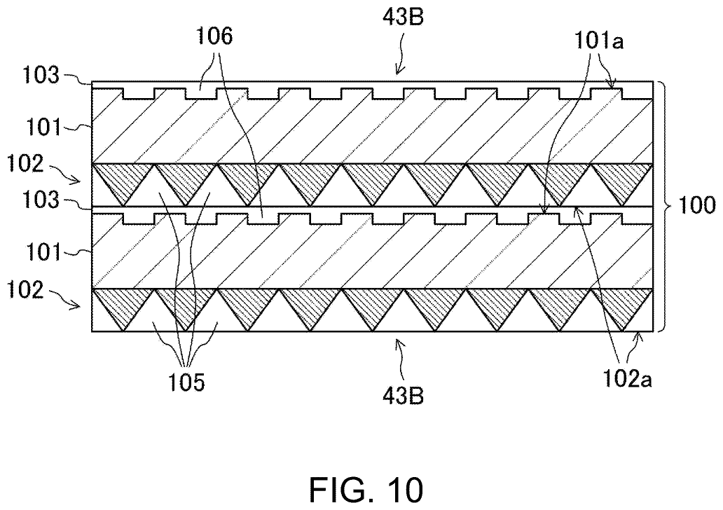

More specifically, in the backlight unit 40 of the embodiment shown in FIG. 2 or FIG. 9, described above, a stacked light diffusion sheet 100 in which two second light diffusion sheets 43B are adhered to each other, as shown in FIG. 10, may be used instead of the upper-side first light diffusion sheet 43A and the second light diffusion sheet 43B. In the stacked light diffusion sheet 100, the two second light diffusion sheets 43B are adhered to each with the flattening printed layer 103 of the lower-side second light diffusion sheet 43B therebetween. For example, the stacked light diffusion sheet 100 may be formed by printing the light-transmitting ink 106 containing a UV-curable resin on the second surface 101a of each second light diffusion sheet 43B, and then curing the light-transmitting ink 106 by ultraviolet rays in a state where the first surface 102a of the upper-side second light diffusion sheet 43A is pressed against the second surface 101a of the lower-side second light diffusion sheet 43B. Note that in the stacked light diffusion sheet 100, the first light diffusion sheet 43A not having the flattening printed layer 103 or another light diffusion sheet may be provided instead of the upper-side light diffusion sheet 43B. Further, in the stacked light diffusion sheet 100 shown in FIG. 10, the second surfaces 101a of the respective light diffusion sheets 43B are adhered to each other so as to form light emission surfaces, but instead, the second surfaces 101a of the respective light diffusion sheets 43B may be adhered to each other so as to form light entrance surfaces. In this case, the first light diffusion sheet 43A not having the flattening printed layer 103 or another light diffusion sheet may be provided instead of the lower-side light diffusion sheet 43B. As described above, by adhering the light diffusion sheets to each other, the risk of damaging the light diffusion sheets can be reduced, enabling an improvement in yield, in comparison with a case in which the plurality of light diffusion sheets are handled individually, and moreover, the time required to assemble the liquid crystal display device can be reduced, enabling an improvement in throughput.

Furthermore, in the second light diffusion sheet 43B of the above embodiment, the flattening printed layer 103 is formed by printing the light-transmitting ink 106 on the second surface 101a, but instead, a flattening layer constituted by a light-transmitted transmitting resin may be formed by a method other than printing so as to cover the irregularities on the second surface 101a, or in other words the matte surface. For example, a flattening layer constituted by a light-transmitting resin may be provided by applying a liquid light-transmitting UV-curable resin using a roll coater so as to cover the irregularities on the matte surface serving as the second surface 101a of the second light diffusion sheet 43B, and then irradiating the resin with ultraviolet rays.

### REFERENCE SIGNS LIST

1 TFT substrate
2 CF substrate
3 Liquid crystal layer
5 Liquid crystal display panel
6 First polarizing plate
7 Second polarizing plate
40 Backlight unit
41 Reflective sheet
42 Light source
43 Light diffusion sheet
43A First light diffusion sheet
43B Second light diffusion sheet
44A Wavelength selection sheet
44B Color conversion sheet
45 First prism sheet
46 Second prism sheet
48 Glass plate
50 Liquid crystal display device
50a Display screen
100 Stacked light diffusion sheet
101 Base material layer
101a Second surface
102 Light diffusion layer
102a First surface
103 Flattened printed layer
105 Recess
106 Light-transmitting ink
107 Particle
111 Ridge line of recess
112 Center of recess

1. A light diffusion sheet having a plurality of inverted substantially polygonal pyramid-shaped recesses provided on a first surface that serves as a light emission surface or a light entrance surface, wherein
a second surface on the opposite side to the first surface is a matte surface, and
a flattening printed layer constituted by light-transmitting ink is provided so as to cover irregularities on the matte surface.

2. The light diffusion sheet according to claim 1, wherein
the thickness of the flattening printed layer is 5 μm or more.

3. The light diffusion sheet according to claim 1, wherein
a plurality of particles are added to the flattening printed layer.

4. The light diffusion sheet according to claim 3, wherein
an average particle size of the plurality of particles is larger than the thickness of the flattening printed layer.

5. The light diffusion sheet according to claim 3, wherein
a mass ratio of the plurality of particles to the light-transmitting ink in the flattening printed layer is 1% or more and 10% or less.

6. The light diffusion sheet according to claim 1, wherein
the plurality of recesses are formed in an inverted substantially square pyramid shape and arranged in a two-dimensional matrix pattern.

7. The light diffusion sheet according to claim 1, wherein
a ten-point average roughness Rz according to JIS B 0601-1994 of the irregularities on the matte surface is 50 μm or less.

8. A backlight unit incorporated into a liquid crystal display device in order to guide light emitted from a plurality of light sources to a display screen, comprising
the light diffusion sheet according to claim 1, which is provided between the display screen and the plurality of light sources.

9. A liquid crystal display device comprising:
the backlight unit according to claim 8; and
a liquid crystal display panel.

10. An information device comprising the liquid crystal display device according to claim 9.

11. A stacked light diffusion sheet comprising:
the light diffusion sheet according to claim 1; and
another light diffusion sheet adhered to the light diffusion sheet with the flattening printed layer therebetween.

12. A light diffusion sheet in which a plurality of inverted substantially polygonal pyramid-shaped recesses are provided on a first surface that serves as a light emission surface or a light entrance surface, wherein
a second surface on the opposite side to the first surface is a matte surface, and
a flattening layer constituted by a light-transmitting resin is provided so as to cover irregularities on the matte surface.
